(19) United States
(12) Patent Application Publication
(10) Pub. No.: US 2006/0133469 A1
(43) Pub. Date: Jun. 22, 2006

(54) Two-window recovered clock jitter analysis

(76) Inventors: Dan S. Froelich, Beaverton, OR (US); Per E. Fornberg, Portland, OR (US); Andrew M. Volk, Granite Bay, CA (US)

Correspondence Address: Schwegman, Lundberg, Woessner & Kluth, P.A., P.O. Box 2938, Minneapolis, MN, 55402, US

(21) Appl. No.: 10/750,168

(22) Filed: Dec. 31, 2003

(51) Int. Cl. H04B 3/46

(52) U.S. Cl. 375/226

(57) ABSTRACT

Jitter in a clock signal is evaluated. A period of the clock is recovered from the clock signal in a first window, and the clock signal is evaluated for jitter within a second window that is smaller than the first window and located within the first window.

### FIELD OF THE INVENTION

The invention relates generally to analyzing jitter in a digital clock signal, and more specifically to a two-window recovered clock jitter analysis system and method.

### BACKGROUND

When digital signals are transmitted across electrical connections, the impedances and other characteristics of the electrical connections have an effect on the signal. Conductors are imperfect to varying degrees, and the transmitted power must be of sufficient to result in an adequate signal-to-noise ratio where the signal is received.

Although digital signals are typically considered to have one of two voltage levels, in reality this is an ideal that is not physically possible to achieve. Digital signals must transition from one voltage to another over a period of time, which is dependent on the circuitry creating the signal and on the device or wire that is being driven. Also, various conductor or driven device characteristics can sometimes result in a digital signal's voltage overshooting its intended target voltage or to oscillate slightly about the intended voltage.

Because the transition from one voltage level to another can take a period of time that is influenced by other circuit factors, it is sometimes difficult to specify exactly when a digital signal's voltage level will cross a threshold point and be considered to be at one signal level or another. Variations in timing occur, even in relatively stable digital circuits such as digital clock signal circuits. This timing difference from the average or expected transition time is called jitter, and is often measured to ensure that a clock signal is of adequate quality for a particular intended use.

Unfortunately, standards for jitter measurement are not well-defined. Further, some digital clock systems now employ clocks that intentionally change slightly in frequency, and even in rate of change of frequency, making measurement of jitter and meaningful expression of the result even more difficult.

It is therefore desired to measure jitter in a meaningful way, even in the presence of a clock signal that varies in frequency.

### BRIEF DESCRIPTION OF THE FIGURES

FIG. 1 illustrates an example clock signal and first and second windows, consistent with an embodiment of the present invention.

FIG. 2 shows a plot of the computed period of a non-spread spectrum clock versus the number of clock periods used for the first window size, consistent with an embodiment of the present invention.

FIG. 3A shows a graph of the recovered clock period for a variety of clock recovery windows shifted over a full spread spectrum clock cycle, consistent with an embodiment of the present invention.

FIG. 3B shows a magnified view of the graph of FIG. 3A, showing the recovered clock period for a variety of clock recovery windows shifted over a full spread spectrum clock cycle, consistent with an embodiment of the present invention.

FIG. 4 shows a graph illustrating jitter error for various jitter analysis window sizes, where the jitter analysis window is shifted over a full spread spectrum clock cycle, consistent with an embodiment of the present invention.

FIG. 5 is a flowchart, illustrating one example method of practicing the present invention.

### DETAILED DESCRIPTION

In the following detailed description of sample embodiments of the invention, reference is made to the accompanying drawings which form a part hereof, and in which is shown by way of illustration specific sample embodiments in which the invention may be practiced. These embodiments are described in sufficient detail to enable those skilled in the art to practice the invention, and it is to be understood that other embodiments may be utilized and that logical, mechanical, electrical, and other changes may be made without departing from the spirit or scope of the present invention. The following detailed description is, therefore, not to be taken in a limiting sense, and the scope of the invention is defined only by the appended claims.

The present invention provides in various embodiments a system for measuring jitter of a clock signal. The clock signal is in various embodiments an independently provided clock signal, or a clock signal derived or recovered from another signal such as a data signal. A clock period is determined by evaluating the clock signal within a first window. A clock's jitter is then evaluated within a second window, the second window being smaller than the first window and located within the first window. Determination of the clock signal's jitter within the second window comprises in some embodiments measurement of jitter with respect to the expected clock period determined by evaluating the clock signal within the first window. Such a system enables characterization of jitter in traditional digital clocks, as well as in clocks that change over time such as a spread spectrum clock or a clock undergoing thermal frequency drift.

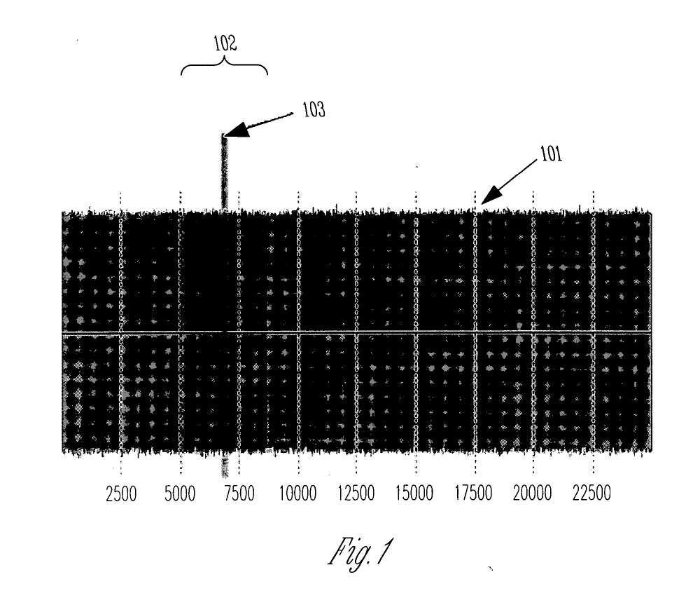

FIG. 1 illustrates an example clock signal and first and second windows, consistent with an embodiment of the present invention. A clock signal 101 is shown, including approximately 25,000 transitions or cycles. A first window 102 of 3,500 cycles is also shown, in which the clock signal is recovered and an average period is determined. At 103, a second, smaller window of 250 cycles is centered on the first window. This second window is used to calculate jitter, or deviation from the expected transition point of the clock signal. Determination of jitter within the second window is performed based on the average clock period within the first window, facilitating accurate jitter measurement even in applications where the clock frequency changes slowly over time. Although the examples shown here utilize a second window contained within the first window, other embodiments include a second window outside the first window, such as closely following the first window. Such applications will likely benefit from keeping the second window reasonably near in time to the first window as the recovered average clock period from the first window may well change over time, resulting in use of an inaccurate average clock period for jitter calculation within the second window.

Although some clock signals drift slightly due to thermal changes in electrical components, a case that is perhaps more significant to modern technology is what has become known as a spread spectrum clock. Such a clock changes slightly in frequency over time to reduce energy and electromagnetic emissions at any one specific frequency, and is often employed to reduce electromagnetic emissions to ensure that maximum emission limits such as those put forth by the Federal Communications Commission are not exceeded. These changes in frequency necessitate a local determination of clock frequency over a period significantly smaller than the period of variation of the clock frequency to make accurate jitter measurements.

In one particular embodiment of a PCI Express bus employing spread spectrum clocking, the clock period varies from 400 ps to 402 ps and back over a period of about 75,000 clock cycles. The first window size 102 of FIG. 1 is selected to be about 1/20 the spread spectrum clock modulation frequency, or 3,500 cycles, as is shown in FIG. 1. The PCI Express specification indicates that jitter is to be measured over a period of 250 clock cycles, which in the example of FIG. 1 is the second window 103.

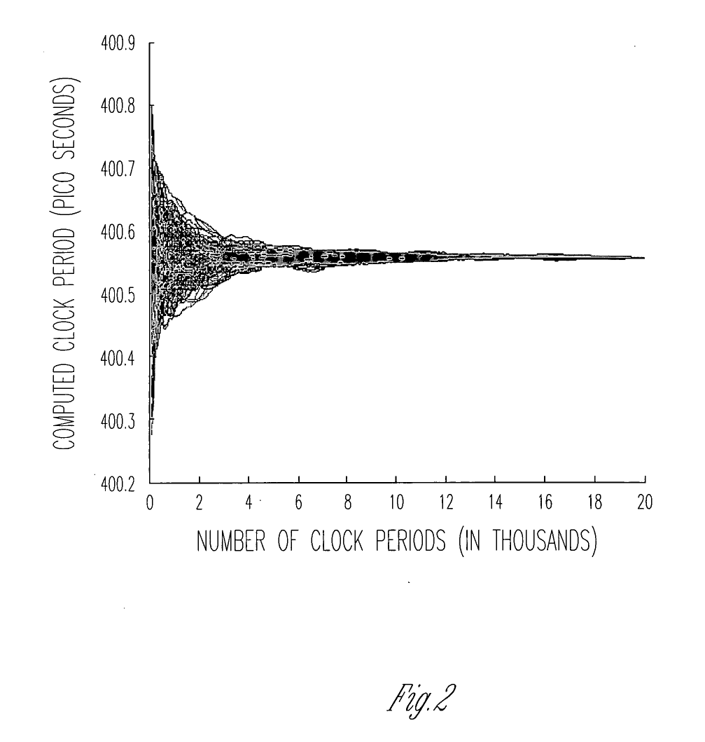

The first window size is desirably small enough to remain substantially unaffected by the spread spectrum change in the clock frequency, but large enough to make an accurate determination of the average period size of the clock. FIG. 2 shows a plot of the computed period of a non-spread spectrum clock versus the number of clock periods used for the first window size (in thousands of clock periods), using various methods of calculating the clock period from the sampled clock data. It shows generally that variation in measured clock period is relatively large in the hundreds range of samples, but reduces substantially in the low-to-mid thousands of clock cycles. This suggests that a first window size of at least a few thousand will yield significantly more accurate results than a smaller first window size.

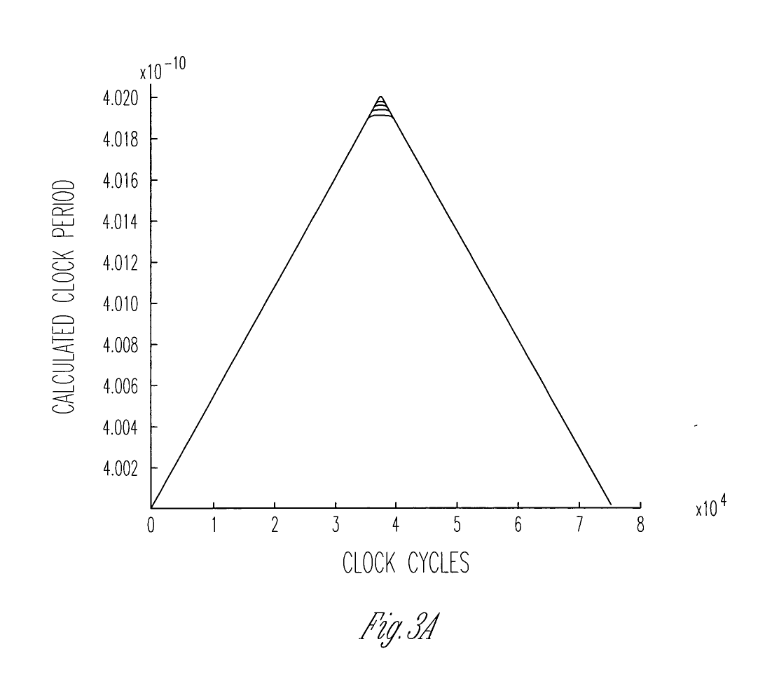

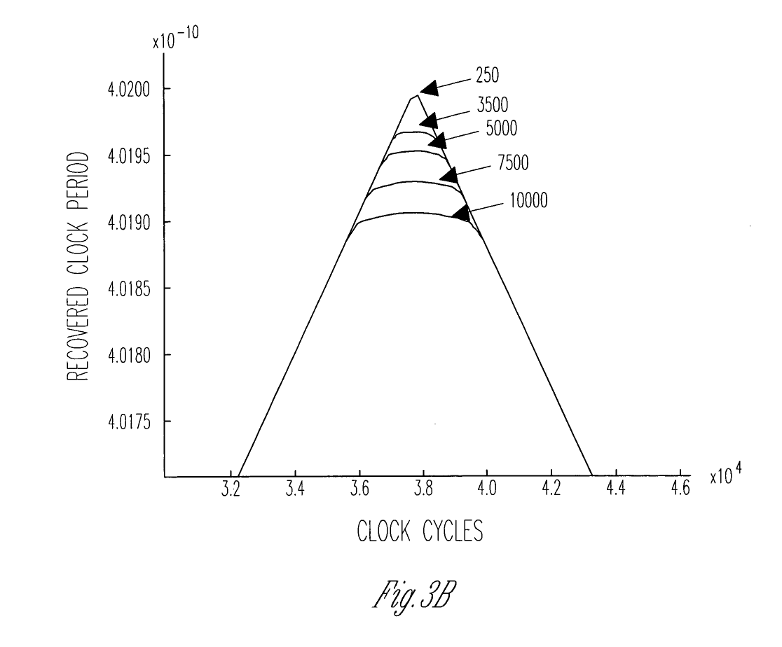

The first window size could simply be chosen to be 10,000 cycles or more based on the data of FIG. 2, but this would result in averaging over too large a time to provide accurate results when a spread spectrum clock that changes linearly with time is used. Such a clock is shown generally in the recovered clock illustration of FIG. 3A, and a magnified view showing the resulting inaccuracies near the transition from increasing frequency to decreasing frequency is shown in FIG. 3B.

In FIG. 3A, the clock can be seen to vary from a period of 400 ps to 402 ps, changing linearly over a time of 37,500 cycles, at which point the clock sharply changes to a linear reduction in period from 402 ps to 400 ps between 37,500 cycles and 75,000 cycles. This is significant because large first window sizes will tend to average out a measured clock period over a larger time, resulting in less accuracy near points at which the rate of change of the period of the clock is not linear, such as at the peak at 37,500 cycles. There, the rate of change of the clock abruptly changes, and inaccuracies in the recovered clock period become more likely. In one particular embodiment of the present invention, the clock frequency actually changes over a period of 75,570 cycles, corresponding to a maximum allowable rate of 33 kHz.

FIG. 3B shows a close-up view of FIG. 3A, illustrating how various first window sizes alter the measured average period of a recovered clock signal. Using a first window of only 250 cycles would result in relatively little error as evidenced by little rounding of the peak in FIG. 3B, but as seen in FIG. 2 is not a great enough time over which to obtain an accurate average. The figure of 3,500 cycles, or approximately 1/20 the spread spectrum modulation period of 75,000 cycles, is therefore selected as a good compromise between the sample size error shown in FIG. 2 and the averaging error shown in FIG. 3B. A variety of other spread-spectrum clock frequency profiles other than the linear rate of frequency change profile shown in FIGS. 3A and 3B may be used, and each will likely have unique characteristics that affect averaging error and the resulting choice of first window size for each particular application.

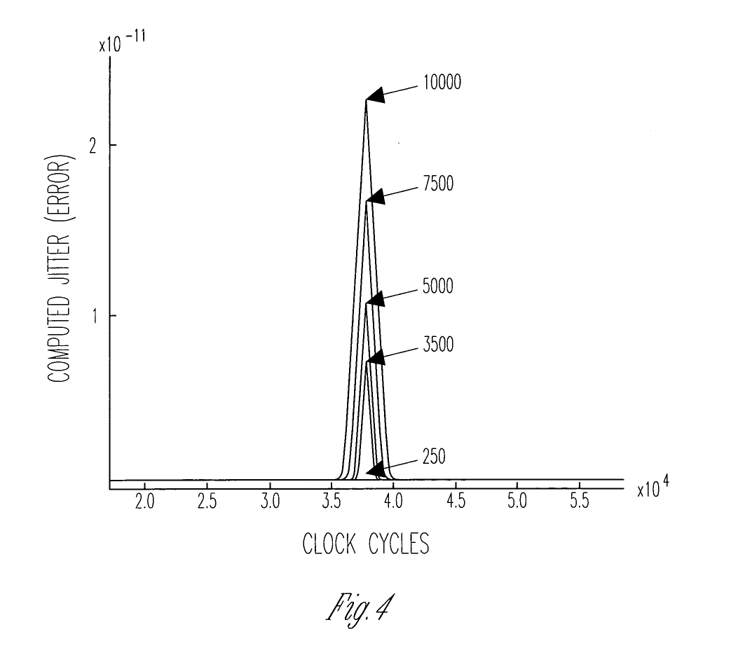

The second window 103 over which jitter is measured is similarly susceptible to error as a result of sharp changes in the rate of frequency change of a spread spectrum clock, as is shown in FIG. 4. This diagram illustrates the computed jitter error, or jitter from a jitter-free clock, resulting from sweeping a second window or jitter analysis window of varying sizes across the frequency transition point of the spread spectrum clock. As the spread spectrum clock frequency changes from linearly increasing to linearly decreasing at 37,500 cycles, the computed jitter rises sharply for relatively large jitter analysis window sizes. As the figure illustrates, the jitter error is minimal for a window size of 250, but increases significantly for window positions near the transition of the spread spectrum clock frequency rate of change when using larger jitter analysis windows.

Along the rising and falling linear slopes of the frequency transition profile for the spread spectrum clock illustrated in FIG. 3A, the computed jitter for a jitter-free clock signal will likely remain essentially constant, as the changing frequency will result in some jitter error. The larger the size of the first window, and the greater the second window's offset from the center of the first window, the larger this computed jitter error will be, due to the larger variation in clock frequency across the second window. This error will be reduced somewhat as the first window incorporates clock cycles near the transition point, but otherwise dictates using a reasonably small first window size, reinforcing our selection of a reasonably small 3500 clock cycle first window.

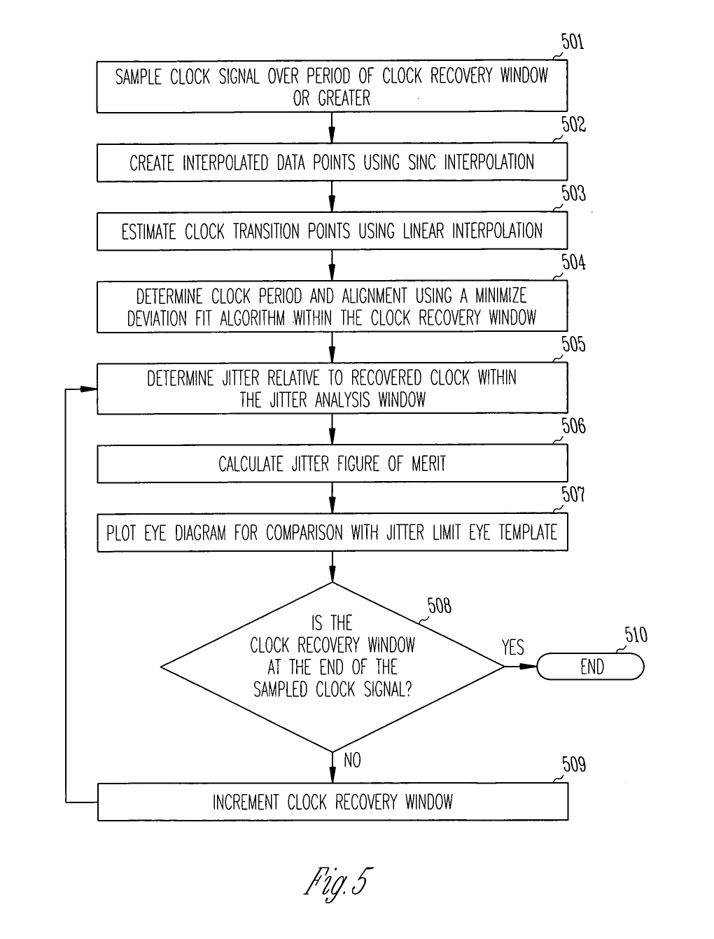

FIG. 5 is a flowchart, illustrating a method of practicing one embodiment of the present invention. At 501, a clock signal such as a spread spectrum clock is sampled over a period at least as long as the clock recovery window, which in the present example is a 3500 cycle window. Because a high sampling rate is desirable for greater accuracy, a 50 ps sampling rate is used to sample the 400 ps spread spectrum clock. At 502, the sampled clock signal is interpolated if necessary to produce intermediate data points using Sinc interpolation. In this particular embodiment, two intermediate data points are produced between each 50 ps sample point, resulting in data points approximately every 17 picoseconds. The clock transition points are then estimated using linear interpolation at 503, and the clock period and alignment with the sampled data is determined using a minimize deviation fit algorithm.

Next, jitter is determined relative to the recovered clock signal at 505 within the jitter analysis window, which is a 250 cycle window centered within the clock recovery window. From the determined jitter, various statistics can be calculated, including such things as maximums, averages, standard deviations, and other such data. At least one figure of merit quantifying the measured jitter is calculated at 506, and an eye diagram is plotted for comparison with a template defining the maximum allowable jitter.

At 508, the clock recovery window is evaluated to determine whether it is at the end of the clock period sampled at 501. If it is not at the end of the sampled data, the clock recovery window is moved forward one clock cycle at 509, and the process repeats from 505. If the clock recovery window is at the end of the sampled clock data, the process ends at 510.

These examples illustrate how a clock recovery window and a jitter analysis window positioned within the clock recovery window are employed together to perform measurement of jitter. Although one specific example of analysis of a PCI Express spread spectrum clock has been discussed here in detail, it is only one example of an application of the two-window jitter analysis method of the present invention. Various embodiments of the invention will include a variety of sampling techniques, clock types, and evaluation algorithms, all of which are within the scope of the present invention. The two-window jitter measurement system provided here is particularly versatile relative to previous systems because it can be used to measure jitter in both traditional and spread spectrum clocks, and can provide results that are meaningful for both cases. The method can also be employed repeatedly, such as in the example of FIG. 5 in which the clock recovery window is swept across a series of sampled clock data.

The examples presented here further illustrate how window selection results in filtering various signal variation frequency components from the jitter analysis, which has application outside the scope of spread spectrum clock signals. For example, a low-frequency clock variation caused by thermal drift can be filtered out by adequately small first window size selection.

Specific embodiments have been illustrated and described herein, but it will be appreciated by those of ordinary skill in the art that any arrangement which is calculated to achieve the same purpose may be substituted for the specific embodiments shown. This application is intended to cover any adaptations or variations of the invention. It is intended that this invention be limited only by the claims, and the full scope of equivalents thereof.

1. A method of measuring jitter, comprising:
evaluating a clock signal within a first window;
determining a recovered clock period from the clock signal within the first window;
evaluating the clock signal within a second window, the second window being smaller than the first window; and
determining the clock signal's jitter within the second window.

2. The method of measuring jitter of claim 1, wherein the second window is located within the first window.

3. The method of measuring jitter of claim 1, wherein the second window is at least partially located outside the first window.

4. The method of measuring jitter of claim 1, wherein the clock signal is recovered from a data signal.

5. The method of measuring jitter of claim 1, further comprising determining a jitter figure of merit from evaluation of jitter within the second window.

6. The method of measuring jitter of claim 1, wherein the first window is a fraction of a modulation period of a spread spectrum clock.

7. The method of measuring jitter of claim 1, further comprising evaluating the clock signal within more than one second window, each second window being smaller than the first window and located within the first window.

8. The method of measuring jitter of claim 1, wherein the clock signal is a PCI Express bus clock signal.

9. The method of measuring jitter of claim 1, wherein the second window position is approximately centered within the first window.

10. The method of measuring jitter of claim 1, further comprising sampling the clock signal for evaluation.

11. The method of measuring jitter of claim 10, further comprising using Sinc interpolation to produce interpolated sampling points.

12. The method of measuring jitter of claim 11, further comprising using linear interpolation to estimate transition points.

13. The method of measuring jitter of claim 1, wherein determining a recovered clock period comprises employing a minimize deviation fit algorithm to the clock signal within the first window.

14. The method of measuring jitter of claim 1, wherein determining the clock signal's jitter within the second window comprises measuring the difference between an expected clock transition point and an actual transition point for each clock transition point within the window.

15. The method of measuring jitter of claim 1, further comprising generation of an eye pattern, and comparison of the generated eye pattern with an eye template defining maximum allowable jitter.

16. A jitter measurement apparatus, the apparatus comprising a clock signal measurement module operable to:
evaluate a clock signal within a first window;
determine a recovered clock period from the clock signal within the first window;
evaluate the clock signal within a second window, the second window being smaller than the first window and located within the first window; and
determine the clock signal's jitter within the second window.

17. The jitter measurement apparatus of claim 16, wherein the second window is located within the first window.

18. The jitter measurement apparatus of claim 16, wherein the second window is at least partially located outside the first window.

19. The jitter measurement apparatus of claim 16, the apparatus further operable to recover the clock signal from a data signal.

20. The jitter measurement apparatus of claim 16, the clock signal measurement module further operable to determine a jitter figure of merit from evaluation of jitter within the second window.

21. The jitter measurement apparatus of claim 16, wherein the first window is a fraction of a modulation period of a spread spectrum clock.

22. The jitter measurement apparatus of claim 16, the clock signal measurement module further operable to evaluate the clock signal within more than one second window, each second window being smaller than the first window and located within the first window.

23. The jitter measurement apparatus of claim 16, wherein the clock signal is a PCI Express bus clock signal.

24. The jitter measurement apparatus of claim 16, wherein the second window position is approximately centered within the first window.

25. The jitter measurement apparatus of claim 16, the clock signal measurement module further operable to sample the clock signal for evaluation.

26. The jitter measurement apparatus of claim 25, the clock signal measurement module further operable to produce interpolated sampling points using Sinc interpolation.

27. The jitter measurement apparatus of claim 26, the clock signal measurement module further operable to estimate transition points using linear interpolation.

28. The jitter measurement apparatus of claim 16, wherein determining a recovered clock period comprises employing a minimize deviation fit algorithm to the clock signal within the first window.

29. The jitter measurement apparatus of claim 16, wherein determining the clock signal's jitter within the second window comprises measuring the difference between an expected clock transition point and an actual transition point for each clock transition point within the window.

30. The jitter measurement apparatus of claim 16, the clock measurement module further operable to generate an eye chart, the eye chart configured for comparison with an eye pattern template indicating maximum allowable jitter.

31. A machine-readable medium with instructions coded thereon, the instructions when executed operable to cause a computerized system to:
evaluate a clock signal within a first window;
determine a recovered clock period from the clock signal within the first window;
evaluate the clock signal within a second window, the second window being smaller than the first window and located within the first window; and
determine the clock signal's jitter within the second window.

32. The machine-readable medium of claim 31, wherein the second window is located within the first window.

33. The machine-readable medium of claim 31, wherein the second window is at least partially located outside the first window.

34. The machine-readable medium of claim 31, wherein the clock signal is recovered from a data signal.

35. The machine-readable medium of claim 31, the instructions further operable when executed to calculate a jitter figure of merit from evaluation of jitter within the second window.

36. The machine-readable medium of claim 31, wherein the first window is a fraction of a modulation period of a spread spectrum clock.

37. The machine-readable medium of claim 31, the instructions further operable when executed to evaluate the clock signal within more than one second window, each second window being smaller than the first window and located within the first window.

38. The machine-readable medium of claim 31, wherein the clock signal is a PCI Express bus clock signal.

39. The machine-readable medium of claim 31, wherein the second window position is approximately centered within the first window.

40. The machine-readable medium of claim 31, the instruction further operable when executed to sample the clock signal for evaluation.

41. The machine-readable medium of claim 40, the instructions further operable when executed to produce interpolated sampling points using Sinc interpolation.

42. The machine-readable medium of claim 41, the instructions further operable when executed to estimate transition points using linear interpolation.

43. The machine-readable medium of claim 31, wherein determining a recovered clock period comprises employing a minimize deviation fit algorithm to the clock signal within the first window.

44. The machine-readable medium of claim 31, wherein determining the clock signal's jitter within the second window comprises measuring the difference between an expected clock transition point and an actual transition point for each clock transition point within the window.

45. The machine-readable medium of claim 31, the instructions further operable to generate an eye chart, the eye chart configured for comparison with an eye pattern template indicating maximum allowable jitter.
